(19) United States
(12) Patent Application Publication
(10) Pub. No.: US 2015/0025927 A1
(43) Pub. Date: Jan. 22, 2015

(54) MISSION COMPONENT EVALUATION AND RESPONSE ARCHITECTURE

(71) Applicant: Raytheon Company, Waltham, MA (US)

(72) Inventors: Paul C. Hershey, Ashburn, VA (US); Douglas E. Toppin, Ashburn, VA (US); Jason Dudash, Arlington, VA (US)

(21) Appl. No.: 13/943,065

(22) Filed: Jul. 16, 2013

(51) Int. Cl. G06Q 10/06

(52) U.S. Cl. CPC G06Q 10/063112
USPC 705/7.14

(57) ABSTRACT

This document discusses, among other things, apparatus and methods for context-aware mission management. In an example, a system can include a processing center and a plurality of mobile devices. The processing center can be configured to receive one or more mission objectives for one or more mission stages, and to receive information from a plurality of sources, the processing center including a data broker reasoner (DBR) configured to compare the information to the one or more mission objectives and to provide role-based task information for accomplishing the one or more mission objectives. The plurality of mobile devices can be configured to wirelessly communicate with the processing center, to receive login information, to register with the processing center using the login information and to display a portion of the role-based task information associated with the login information.

### BACKGROUND

Missions, such as military and civilian missions, require careful examination of mission components, hardware and software, prior to and during the missions. If a problem is detected with any of these components, then a response decision is required. The time frame for the response decision can vary and can depend upon the criticality of the component to the mission. Current mission planning and management systems provide varying levels of status information but lack robust automated response decision making capabilities as well as capabilities to communicate mission information in a concise and efficient manner between system users and to efficiently transition mission information between mission phases.

### OVERVIEW

This document discusses, among other things, apparatus and methods for context-aware mission management. In an example, a system can include a processing center and a plurality of mobile devices. The processing center can be configured to receive one or more mission objectives for one or more mission stages, and to receive information from a plurality of sources, the processing center including a data broker reasoner (DBR) configured to compare the information to the one or more mission objectives and to provide role-based task information for accomplishing the one or more mission objectives. The plurality of mobile devices can be configured to wirelessly communicate with the processing center, to receive login information, to register with the processing center using the login information and to display a portion of the role-based task information associated with the login information.

This overview is intended to provide a general overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally of an example mission evaluation and response architecture.

FIG. 2 illustrates generally electronic information exchanges of an example mission evaluation and response architecture.

### DETAILED DESCRIPTION

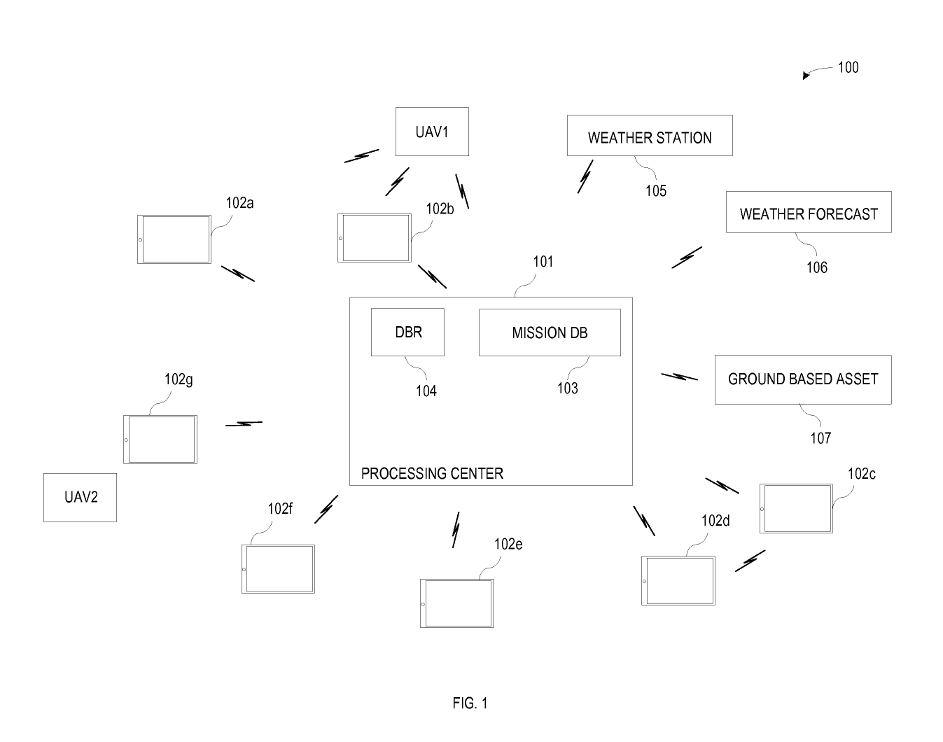

FIG. 1 illustrates generally an example mission evaluation and response architecture 100 including a processing center 101 and a number of mobile devices 102a-102g. In certain examples, the processing center 101 can access mission information for one or more predefined missions. Mission data can be entered into the processing center 101 from one or more sources registered with the processing center 101 and authorized to provide mission data. In an example, mission information can be entered into and retrieved from a mission database 103. The processing center 101 can use the mission data to provide display information to the mobile devices 102a-102g. In certain examples, the display information can include task information intended to direct a user of a mobile device 102a-102g to execute the mission or tasks involved with completing or accomplishing the mission. In certain examples, assets, such as personnel and equipment, can be assigned to one or more missions. In certain examples, each mission can include multiple stages, for example, stages can include one or more of a planning stage, pre-mission stage. a launch and recovery stage, an on-mission stage, a post-mission stage, a maintenance stage, an analysis stage, etc.

Information sources that the processing center 101 can receive information from can include, but are not limited to, dedicated data producers, command assets, mobile devices associated with command personnel, and command databases. Examples of dedicated data producers can include, but are not limited to, weather stations 105, weather forecast centers 106, global positioning systems, radar systems, communication intercept databases, sensors, cameras, etc. Examples of command assets can include manned and unmanned aircraft (UAV1, UAV2), ground or land based vehicles 107, sea-base vehicles, satellites, weapons, personnel, etc. Examples of command databases can include intelligence databases such as databases identifying objects of interest, maintenance databases associated with command assets, training and status databases associated with command personnel, wireless coverage databases, etc.

In certain examples, each of the mobile devices 102a-102g can be configured to register with the processing center 101. Mobile devices 102a-102g, such as tablet computers, can assist a user with registering the mobile device 102a-102g with the processing center. In certain examples, the process of registering the mobile device 102a-102g with the processing center can generate login information associated with the user. For example, the mobile device can prompt the user for login information and can receive the login information via a keyboard, touchscreen, card reader or other sensor associated with the mobile device. The login information can include, but is not limited to, a username, password, role, and mission passcode(s). In some examples, the login information can be enhanced with geo-location information provided by the mobile device 102a-102g or the user. In certain examples, the login information can associate a mobile device with one or more roles within a mission. In some examples, the login information can provide the DBR with an indication of available assets associated with a mission, a mission objective, or a role-based task.

In certain examples, each mobile device 102a-102g can be associated with one or more roles associated with one or more missions. Roles can include, but are not limited to, mechanic, pilot of a unmanned aerial vehicle (UAV), ground personnel associated with airborne command vehicles, such as the UAV, mission commander, truck driver, squadron leader, munitions officer, etc.

The processing center can include a data broker reasoner (DBR) 104, a mission database 103, processors, and memory configured to store code for receiving information, for processing the received information using the processor and the mission database 103, and for transmitting role-based task information generated by the DBR to each mobile device 102a-102g. In certain examples, the mission database 103 can include information for one or more missions. In some examples, a mission can include a number of mission objectives. Timelines can be associated with each mission objective. In some examples, the mission data base can include a predetermined list of assets associated with each mission or mission objective. Some mission objectives can be programmed to be executed sequentially. Some mission objectives can be programmed to be executed in parallel. Some mission objective tasks can be intertwined with other mission objective tasks such that mission objectives can have some phases that are intended to be executed in parallel as well as other phases intended to be executed sequentially on completion of certain tasks of other phase objectives.

In certain examples, the DBR 104 can compare mission objectives or mission timelines to information received from one or more sources, such as information received by command personnel, information received from command assets, weather information, information about the status and location of objects of interest, status and location information of command assets including command personnel, etc. The DBR can use the comparison to adjust mission objectives or mission timelines based on information received from one or more sources, such as information received by command personnel, information received from command assets, weather information, information about the status and location of objects of interest, status and location information of command assets including command personnel, etc. In some examples, the DBR 104 can create role-based task information and can transmit the role-based task information to only those mobile devices 102a-102g registered with the processing center that correspond to the role of the role-based task information. In certain examples, the DBR can filter role-based information to include role-based information associated with a particular mission and to communicate role-based information associated with the role or location of a particular mobile device, and can exclude role-based information associated with the particular mission but not associated with the role or location of the particular mobile device to reduce communication traffic between the processing center and the mobile device. In addition, transmitting only the information relevant to a user's role can help reduce confusion and increase trust between the user and the mission evaluation and response architecture 100. If additional information is requested by the user, the DBR 104 can, on a device-by-device basis, provide additional information that may be helpful for the user of the mobile device 102a-102g.

As an example of the DBR 104 adjusting or managing mission objectives, a mission can include tasking command assets to locate, capture or destroy an object of interest such as an individual, a target asset, a particular piece of data, a particular signal or a combination thereof. As the mission progresses, a command asset can become disabled. The DBR 104, upon electronically receiving information about the disabled command asset, can task other command assets (e.g. equipment and personnel) to rescue or replace the disabled command asset. The above scenario can take place in a military setting as well as a civilian setting. A military setting might entail a UAV assisting a ground team in locating an object of interest. If a member of the ground team or equipment associated with the mission becomes disabled, including the UAV, the DBR 104 can task other command assets to rescue or replace the disabled asset without waiting for operator intervention.

In a civilian setting, the mission may involve fighting a forest fire and locating people near the path of the fire. If a command asset, such as a fireman on the ground, or an aircraft, is disabled, or the weather changes, the DBR 104 can adjust tasks and can communicated the adjusted tasks of other command assets to recover the disabled fireman, replace the capabilities of the disabled aircraft, and position or move command assets to account for changes in the weather. In certain examples, a mechanic associated with the mission can use a mobile device 102g to communicatively couple the mobile device to an asset to diagnose a faulty asset, such as an aircraft, including but not limited to an unmanned aerial vehicle (UAV2), and can use the DBR 104 to locate parts and personnel necessary to make repairs and get the aircraft mission worthy in a timely fashion. For example, in certain examples the mechanic can use the mobile device 102g to take a photo of the disabled aircraft (UAV2) or connect to diagnostic components of the aircraft (UAV2). The DBR 104 can then use the photo or diagnostic information to provide task information to a mobile device 102f of parts hub personnel associated with the mission so as to locate parts and begin the process of procuring the parts for the repair of the disabled aircraft (UAV2).

It is understood that an object of interest can include both tangible objects and non-tangible objects. Examples of tangible objects of interest can include, but are not limited to, persons, animals, vehicles, moving targets, changes in normal activity flow, drugs, buildings, roads, bridges, equipment or combinations thereof. Examples of non-tangible objects of interest can include, but are not limited to, a group, company, a corporation, a government, electronic data, communication signals, one or more entries in a database, financial transactions, contents of intercepted communications, behavioral analysis of an individual, a group, a corporation, or a government, or combinations thereof.

In certain examples, the DBR can receive various pieces of status information and can evaluate various changes to mission objectives as well as multiple alternative role-based tasks. The DRB can associate a level of success for each evaluation. In certain examples, the alternative mission objective or role based task with the higher success level provides the basis for adjusting a mission objective and for providing adjusted role based tasks. In certain examples, factors such as weather, asset location, asset reallocation for other mission objectives, timeline impacts or combinations thereof can influence a success level of an alternative mission objective or task.

In certain examples, task data on the mobile devices 102a-102g can be cloned from the task data of the DBR 104 as needed. In certain examples, the DBR 104 or each mobile device 102a-102g can monitor location of the mobile device 102a-102g against a wireless coverage map associated with the type of wireless communication the mobile device 102a-102g is capable of communicating over. In certain examples, the wireless coverage map can provide indications of transmission signal strengths for locations within the map area. If the DBR 104 or the mobile device 102a-102g determines that the mobile device 102a-102g is entering an area with reduced communications capabilities, then the data on the mobile device 102a-102g can be cloned at intervals or rates consistent with wireless communication bandwidth availability. In certain examples, bandwidth availability for a mobile device 102a-102g can be dynamic and can change based on a number of parameters including, but not limited to, actual wireless service coverage, the status of a mission, the role associated with the login information of the mobile device 102a-102g, the priority of a pending task associated with the mission, etc. In certain examples, if the DBR 104 or the mobile device 102a-102g determines that the mobile device may lose wireless communication completely, for example, by determining that the location or movement of a mobile device corresponds to a “dead zone” of a coverage map, data for the mobile device 102a-102g can be cloned from a more complete data set of the DBR 104 based on the mission context associated with the mobile device 102a-102g. For example, if it has been determined that a command asset such as a UAV will probably enter an area of diminished communications service, more complete data sets, such as image information can be cloned to the UAV, or to the mobile devices of the UAV pilot or ground crew, so that the UAV can accomplish one or more mission tasks in a timely manner without having communications capabilities with the processing center. In certain examples, the DBR can modulate communications to a mobile device or an asset based on a comparison of the location of the mobile device or asset and the communications capabilities predicted within the location on a communications coverage map.

In certain examples, the DBR can receive a wireless coverage map providing wireless transmission strengths associated with locations within the map. The DBR can monitor wireless communication traffic near a planned location of one or more mobile devices and can compare the planned locations of the mobile devices with the wireless coverage map. The DBR can modulate a communication protocol between the processing center and the mobile devices based on anticipated or sensed wireless communication traffic and the comparison. When the wireless communication traffic is above a traffic threshold, or the planned location of a mobile device corresponds to a dead zone of wireless coverage, the DBR can upload planned task information to the mobile device. In certain examples, the planned task information includes role-based task information that corresponds with a role that is associated with the login information of the mobile device.

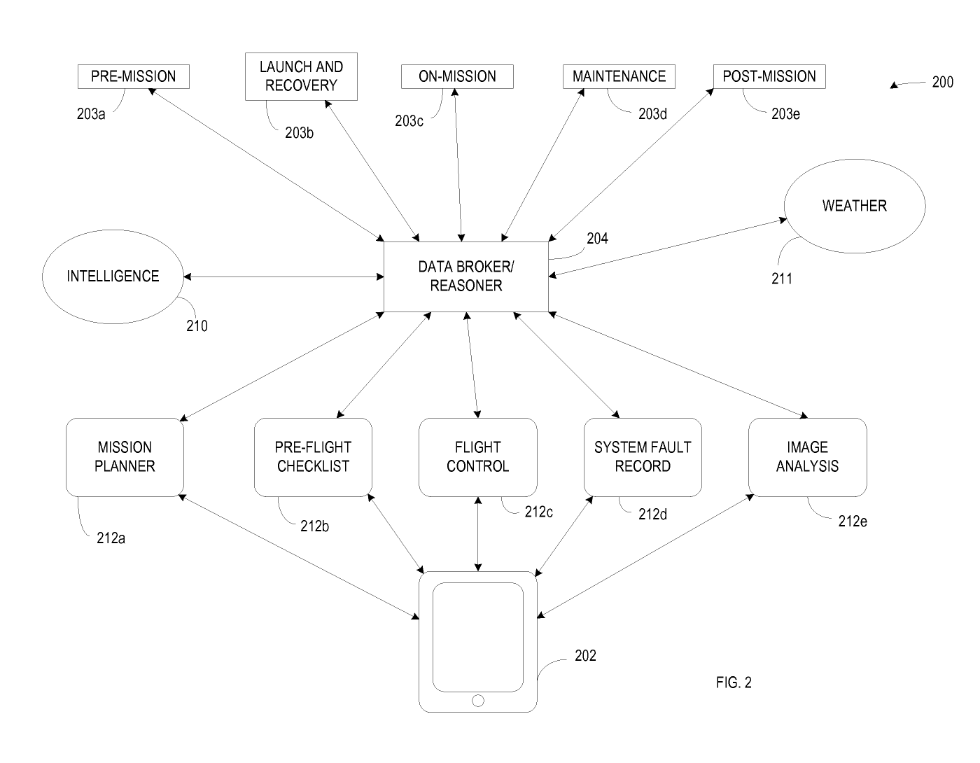

FIG. 2 illustrates generally electronic information exchanges of an example mission evaluation and response architecture 200. In certain examples, electronic information can be exchanged between one or more mission data bases 203a-203e, the data broker reasoner (DBR) 204, one or more information sources 210, 211 and a mobile device 202, sometimes referred to as an intelligent mission console (IMC). The illustrated example shows information flows for a flight based mission. It is understood that other mission types can use the illustrated mission evaluation and response architecture 200 to reduce mission manpower and provide context aware decisions and decision assistance to multiple mission phases and to multiple mission personnel. In the illustrated example, only one mobile device 202 is illustrated. In certain examples, a mission can include multiple mobile devices, including multiple IMCs as well as user interfaces integrated with mission equipment. The DBR 204 can filter display information 212a-212e, for each user interface and IMC based on login information associated with the user of such a device. In certain examples, the DBR 204 can filter display information 212a-212e by the stage of the mission 203a-203e, the location of the mobile device 202, interface or other display device, and the role associated with the user of the display device. The filtered information can allow the mobile device user to focus on the specific task at hand without receiving mission information that can be distracting or confusing. In certain examples, the filtered information can allow a particular user to execute tasks that would have required addition personnel without access to the mission evaluation and response architecture 200.

For the specific flight based mission illustrated in FIG. 2, the DBR 204 can receive information from one or more mission databases 203a-203e. In certain examples, the information from the one or more mission databases 203a-203e can be predetermined via a pre-mission stage 203a such as through a mission planning task and mission planning display information 212a of a mobile device 202. In some examples, the DBR 204 can evaluate mission objectives of the pre-mission stage 203a and can provide task information to prepare for the mission. Tasks associated with the task information can include, but are not limited to, scheduling personnel for the mission, reserving command assets, such as primary equipment, weapons, fuel, parts, support equipment, scheduling training, identifying targets and locations of targets for sensor observation, etc. In certain examples, the DBR 204 can provide planning assistance by indicating conflicts in mission stage timing, providing success evaluation based on historical data, and providing recommendations on alternative mission tasks. As the mission moves from the pre-mission stage 203a, to the launch and recovery 203b and on-mission stages 203c, the DBR 204 can provide task-based and filtered information to one or more mobile devices 202 assigned to, or that correspond to the mission. As events develop, both positive and negative events, the DBR 204 can modify the mission objectives and/or re-task command personnel to accomplish the mission objectives. In certain examples, as discussed above, such modification can be made when weather 211 or intelligence 212 information indicates that alternative mission objectives or tasks have a higher success potential than current mission objectives or tasks. In some examples, the DBR can modify mission objectives or tasks when alternative mission objectives or tasks can be accomplished with greater efficiency in time or effort than current mission objectives or tasks.

In certain examples, the IMC 202 can provide feedback information to the DBR 204 from the user. Such information can include, but is not limited to, status of the tasks assigned to the IMC user, position information of the IMC 202, sensor information such as imagery information from a camera of the IMC 202 or a device associated with the IMC 202. The feedback information can be used by the DBR 204 to evaluate the mission progress and or evaluate alternative mission tasks as the mission progresses through the launch and recovery 203b and the on-mission stages 203c.

Examples of filtered information that the DBR can send to the mobile devices can include, but are not limited to, pre-flight checklists 212b associated with the launch and recovery stage 203b and flight control information associated with the on-mission stage 203c. In certain examples, a maintenance mission stage 203d can be executed in parallel with other mission stages. Objectives associated with a maintenance stage 203d can include, but are not limited to, providing timely repair and status information for all the mission equipment, assisting in troubleshooting of the mission equipment, and in providing alternative operating procedures for equipment experiencing operational difficulties during one or more of the mission stages. In certain examples, maintenance personnel can log into a mobile device 202, such as an IMC, and can receive maintenance display information to support one or more of the mission objectives. In an example, maintenance display information can include system fault information 212d associated with a mission asset such as an aircraft associated with the flight based mission illustrated in FIG. 2.

Upon completion of a mission, a mission stage, or a mission objective, the DBR can conduct a post-mission 203e review or can assist in evaluating mission data to provide a mission summary. In an example, imagery data captured in a mission, such as a fight based mission, can be electronically analyzed 212e to assess fine details of the image data or to compare to other imagery to determine changes that may have occurred between the times when the imagery was captured. The DBR can also provide summaries of equipment and personnel associated with the mission and can provide role-base task information to mission personnel for storing, updating, repairing, recovering, or disposing of mission equipment.

### Additional Notes

In Example 1, a system can include a processing center and a plurality of mobile devices. The processing center can be configured to receive one or more mission objectives for one or more mission stages, and to receive information from a plurality of sources, the processing center including a data broker reasoner (DBR) configured to compare the information to the one or more mission objectives and to provide role-based task information for accomplishing the one or more mission objectives. The plurality of mobile devices can be configured to wirelessly communicate with the processing center, to receive login information, to register with the processing center using the login information and to display a portion of the role-based task information associated with the login information.

In Example 2, the one or more mission stages of Example 1 optionally include a predetermined list of assets for accomplishing the one or more mission objectives, and the DBR of Example 1 optionally is configured to electronically receive asset information from one or more of the plurality of sources, to compare the asset information, the predetermined list of assets and the mission objectives and to adjust one or more tasks associated with the one or more mission objectives of the one or more missions using the comparison of the asset information, the predefined list of assets and the mission objectives of the one or more missions.

In Example 3, the DBR of any one or more of Examples 1-2 optionally is configured to wirelessly communicate a role-based task of the one or more tasks to a mobile device of the one or more mobile devices. In certain examples, role information associated with the role-based task can match role information associated with the login information.

In Example 4, the role-based task of any one or more of Examples 1-3 optionally includes first task information associated with a first role and second task information associated with a second role, and the DBR of any one or more of Examples 1-3 optionally is configured to wireless communicate the first task information to a first mobile device of the plurality of mobile devices registered with the processing center using the role information associate with the login information that associates the mobile device with the first role.

In Example 5, the DBR of any one or more of Examples 1-4 optionally is configured to electronically receive object of interest information from the one or more of the plurality of sources;

In Example 6, the DBR of any one or more of Examples 1-5 optionally is configured to electronically receive command asset information from the one or more of the plurality of sources;

In Example 7, command asset information of any one or more of Examples 1-6 optionally includes status information of an unmanned aerial vehicle.

In Example 8, the plurality of mobile devices of any one or more of Examples 1-7 optionally includes a first mobile device configured to be registered to the processing center in a maintenance role assigned to one mission of the plurality of missions, to display first maintenance task information received from the DBR; to communicatively couple to a command asset, to receive diagnostic information from the command asset; and to provide the diagnostic information to the DBR using a display of the first mobile device, and the DBR of any one or more of Examples 1-7 optionally is configured to compare the diagnostic information to a mission objective of the one mission; to adjust a task of the mission using the comparison; to modify the first maintenance task information according to the adjusted task of the mission to provide second maintenance task information; and to provide display information for the second maintenance task to the first mobile device if the first mobile device is registered to the processing center in the maintenance role assigned to the one mission.

In Example 9, the one or more mission stages of any one or more of Examples 1-8 optionally include a predetermined timeline for accomplishing the one or more mission objectives. The processing center of any one or more of Examples 1-8 optionally is configured to electronically receive weather information from a second one or more sources of the plurality of sources. The DBR of any one or more of Examples 1-8 optionally is configured compare the weather information, the predetermined list of assets, the asset information, and the predetermined timeline, and to adjust one or more tasks associated with one or more mission objectives of the one or more missions using the comparison of the weather information, the predetermined list of assets, the asset information, and the predetermined timeline, and the mission objectives of the one or more missions.

In Example 10, the DBR of any one or more of Examples 1-9 optionally is configured to receive a wireless coverage map providing wireless transmission strengths associated with locations within the map, to monitor wireless communication traffic near a planned location of one mobile device of the mobile devices of the plurality of mobile devices, and to compare the planned location of the mobile device with the wireless coverage map, and to modulate a communication protocol between the processing center and the mobile device using the wireless communication traffic and the comparison.

In Example 11, when the wireless communication traffic is above a traffic threshold, or the planned location corresponds to a dead zone of wireless coverage, the DBR of any one or more of Examples 1-10 optionally in configured to upload planned task information to the mobile device, wherein the planned role-based task information is associated with the login information of the mobile device.

In Example 12, the login information of any one or more of Examples 1-11 optionally includes location information identifying a location of a mobile device of the plurality of mobile devices and mission information associated with a particular mission of the plurality of missions, and the DBR of any one or more of Examples 1-11 optionally is configured to filter the role-based information to include role-based information associated with the particular mission and to include role-based information associated with the location of the mobile device, and to exclude role-based information associated with the particular mission and not associated with the location of the mobile device to reduce communication traffic between the processing center and the mobile device.

In Example 13, the DBR of any one or more of Examples 1-12 optionally is configured to provide the portion of the role-based task information to a mobile device of the plurality of mobile devices based on role information received from the mobile device and on a priority level of a task associated with the role-based task information.

In Example 14, the DBR of any one or more of Examples 1-13 optionally is configured to change the priority level of the task based on the comparison of the information to the one or more mission objectives.

In Example 15, a method can include receiving one or more mission objectives for one or more mission stages at a processing center, receiving information from a plurality of sources at the processing center, comparing the one or more mission objectives with the information using a data broker reasoner of the processing center, providing role-based task information for accomplishing the mission objectives using the comparison of the one or more mission objectives with the information, receiving login information at a mobile device configured to communicatively couple to the processing center, registering the mobile device with the processing center using the login information, identifying a role associated with the login information, and displaying a portion of the role-based task information at the mobile device, wherein the portion is associated with the role associated with the login information.

In Example 16, the method of any one or more of Examples 1-15 optionally includes adjusting a priority level of a mission objective using the information, and the providing role-based task information of any one or more of Examples 1-15 optionally includes providing role-based task information for accomplishing the mission objectives using the priority level of the mission objective.

In Example 17, the receiving information from a plurality of sources at the processing center of any one or more of Examples 1-16 optionally includes receiving weather status information from one or more of a weather satellite, land based weather station, or sea-based weather station, receiving weather forecast information from a weather forecast system, receiving command asset status information from a one or more of a global positioning system or a sensor associated with the command asset, and receiving status information of an object of interest from one or more of aerial image information, or communication information;

In Example 18, the comparing the one or more mission objectives with the information using a data broker reasoner (DBR) of any one or more of Examples 1-17 optionally includes comparing the weather forecast information, the status information of the object of interest, the command asset status information and operational limitations of one or more available assets using the DBR, adjusting a mission objective of the one or more mission objective if the comparison of the weather forecast information, the status information of the object of interest, the command asset status information and operational limitations of one or more available assets indicates a first predicted success level lower than a predetermined threshold for the mission objective using the data broker reasoner, and transmitting second role-based task information associated with the mission objective to one or more mobile devices registered with login role information matching role information associated with the second role-based task information.

In Example 19, the adjusting the mission objective of the one or more mission objectives of any one or more of Examples 1-18 optionally includes adjusting a timeline of the mission objective of the one or more mission objective to provide an adjusted timeline if the comparison of the weather forecast information, the status information of the object of interest, the command asset status information and operation limitations of one or more available assets indicates a second predicted success level higher than the predetermined threshold for the mission objective, and the transmitting second role-based task information associated with the mission objective to one or more mobile devices registered with login role information matching role information associated with the second role-based task information of any one or more of Examples 1-18 optionally includes transmitting a role based timeline associated with the adjusted timeline to the one or more mobile devices registered with login role information matching role information associated with the second role-based task information.

In Example 20, the registering the mobile device of any one or more of Examples 1-19 optionally includes associating the mobile device with a particular mission stage and particular mission objective based on the login information.

Example 21 can include, or can optionally be combined with any portion or combination of any portions of any one or more of Examples 1 through 20 to include, subject matter that can include means for performing any one or more of the functions of Examples 1 through 20, or a machine-readable medium including instructions that, when performed by a machine, cause the machine to perform any one or more of the functions of Examples 1 through 20.

The above detailed description includes references to the accompanying drawings, which form a part of the detailed description. The drawings show, by way of illustration, specific embodiments in which the invention can be practiced. These embodiments are also referred to herein as “examples.” All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and

“A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

What is claimed is:

1. A system comprising:
a processing center configured to receive one or more mission objectives for one or more mission stages, and to receive information from a plurality of sources, the processing center including a data broker reasoner (DBR) configured to compare the information to the one or more mission objectives and to provide role-based task information for accomplishing the one or more mission objectives; and
a plurality of mobile devices configured to wirelessly communicate with the processing center, to receive login information, to register with the processing center using the login information and to display a portion of the role-based task information associated with the login information.

2. The system of claim 1, wherein the one or more mission stages includes a predetermined list of assets for accomplishing the one or more mission objectives; and
wherein the DBR is configured to electronically receive asset information from one or more of the plurality of sources, to compare the asset information, the predetermined list of assets and the mission objectives and to adjust one or more tasks associated with the one or more mission objectives of the one or more missions using the comparison of the asset information, the predefined list of assets and the mission objectives of the one or more missions.

3. The system of claim 2, wherein the DBR is configured to wirelessly communicate a role-based task of the one or more tasks to a mobile device of the one or more mobile devices;
wherein role information associated with the role-based task matches role information associated with the login information.

4. The system of claim 3, wherein the role-based task includes first task information associated with a first role and second task information associated with a second role; and
wherein the DBR is configured to wireless communicate the first task information to a first mobile device of the plurality of mobile devices registered with the processing center using the role information associate with the login information that associates the mobile device with the first role.

5. The system of claim 3, wherein the DBR is configured to electronically receive object of interest information from the one or more of the plurality of sources;

6. The system of claim 3, wherein the DBR is configured to electronically receive command asset information from the one or more of the plurality of sources;

7. The system of claim 6, wherein command asset information includes status information of an unmanned aerial vehicle.

8. The system of claim 2, wherein the plurality of mobile devices includes a first mobile device configured to be registered to the processing center in a maintenance role assigned to one mission of the plurality of missions, to display first maintenance task information received from the DBR; to communicatively couple to a command asset, to receive diagnostic information from the command asset; and to provide the diagnostic information to the DBR using a display of the first mobile device; and
wherein the DBR is configured to compare the diagnostic information to a mission objective of the one mission; to adjust a task of the mission using the comparison; to modify the first maintenance task information according to the adjusted task of the mission to provide second maintenance task information; and to provide display information for the second maintenance task to the first mobile device if the first mobile device is registered to the processing center in the maintenance role assigned to the one mission.

9. The system of claim 2, wherein the one or more mission stages include a predetermined timeline for accomplishing the one or more mission objectives;
wherein the processing center is configured to electronically receive weather information from a second one or more sources of the plurality of sources; and
wherein the DBR is configured compare the weather information, the predetermined list of assets, the asset information, and the predetermined timeline, and to adjust one or more tasks associated with one or more mission objectives of the one or more missions using the comparison of the weather information, the predetermined list of assets, the asset information, and the predetermined timeline, and the mission objectives of the one or more missions.

10. The system of claim 1, wherein the DBR is configured to receive a wireless coverage map providing wireless transmission strengths associated with locations within the map, to monitor wireless communication traffic near a planned location of one mobile device of the mobile devices of the plurality of mobile devices, and to compare the planned location of the mobile device with the wireless coverage map, and to modulate a communication protocol between the processing center and the mobile device using the wireless communication traffic and the comparison.

11. The system of claim 10, wherein, when the wireless communication traffic is above a traffic threshold, or the planned location corresponds to a dead zone of wireless coverage, the DBR uploads planned task information to the mobile device, wherein the planned role-based task information is associated with the login information of the mobile device.

12. The system of claim 1, wherein the login information includes location information identifying a location of a mobile device of the plurality of mobile devices and mission information associated with a particular mission of the plurality of missions; and
wherein the DBR is configured to filter the role-based information to include role-based information associated with the particular mission and to include role-based information associated with the location of the mobile device, and to exclude role-based information associated with the particular mission and not associated with the location of the mobile device to reduce communication traffic between the processing center and the mobile device.

13. The system of claim 1, wherein the DBR is configured to provide the portion of the role-based task information to a mobile device of the plurality of mobile devices based on role information received from the mobile device and on a priority level of a task associated with the role-based task information.

14. The system of claim 13, wherein the DBR is configured to change the priority level of the task based on the comparison of the information to the one or more mission objectives.

15. A method comprising:
receiving one or more mission objectives for one or more mission stages at a processing center;
receiving information from a plurality of sources at the processing center;
comparing the one or more mission objectives with the information using a data broker reasoner of the processing center;
providing role-based task information for accomplishing the mission objectives using the comparison of the one or more mission objectives with the information;
receiving login information at a mobile device configured to communicatively couple to the processing center;
registering the mobile device with the processing center using the login information;
identifying a role associated with the login information; and
displaying a portion of the role-based task information at the mobile device, wherein the portion is associated with the role associated with the login information.

16. The method of claim 15, including adjusting a priority level of a mission objective using the information; and
wherein providing role-based task information includes providing role-based task information for accomplishing the mission objectives using the priority level of the mission objective.

17. The method of claim 16, wherein receiving information from a plurality of sources at the processing center includes:
receiving weather status information from one or more of a weather satellite, land based weather station, or sea-based weather station;
receiving weather forecast information from a weather forecast system;
receiving command asset status information from a one or more of a global positioning system or a sensor associated with the command asset; and
receiving status information of an object of interest from one or more of aerial image information, or communication information;

18. The method of claim 17, wherein comparing the one or more mission objectives with the information using a data broker reasoner (DBR) includes:
comparing the weather forecast information, the status information of the object of interest, the command asset status information and operational limitations of one or more available assets using the DBR; and
adjusting a mission objective of the one or more mission objective if the comparison of the weather forecast information, the status information of the object of interest, the command asset status information and operational limitations of one or more available assets indicates a first predicted success level lower than a predetermined threshold for the mission objective using the data broker reasoner; and
transmitting second role-based task information associated with the mission objective to one or more mobile devices registered with login role information matching role information associated with the second role-based task information.

19. The method of claim 18, wherein adjusting the mission objective of the one or more mission objectives includes adjusting a timeline of the mission objective of the one or more mission objective to provide an adjusted timeline if the comparison of the weather forecast information, the status information of the object of interest, the command asset status information and operation limitations of one or more available assets indicates a second predicted success level higher than the predetermined threshold for the mission objective; and
wherein the transmitting second role-based task information associated with the mission objective to one or more mobile devices registered with login role information matching role information associated with the second role-based task information includes transmitting a role based timeline associated with the adjusted timeline to the one or more mobile devices registered with login role information matching role information associated with the second role-based task information.

20. The method of claim 15, wherein registering the mobile device includes associating the mobile device with a particular mission stage and particular mission objective based on the login information.
